(19) United States
(12) Patent Application Publication
(10) Pub. No.: US 2025/0063963 A1
(43) Pub. Date: Feb. 27, 2025

(54) ROW CLEANER WITH SCRAPER BLADES FOR ROW UNITS OF AN AGRICULTURAL IMPLEMENT

(71) Applicant: CNH Industrial America LLC, New Holland, PA (US)

(72) Inventor: Brian Michael Craig, Congerville, IL (US)

(21) Appl. No.: 18/807,284

(22) Filed: Aug. 16, 2024

Related U.S. Application Data
(60) Provisional application No. 63/578,394, filed on Aug. 24, 2023.

(51) Int. Cl. A01B 15/16; A01B 27/00; A01B 35/16

(52) U.S. Cl. CPC A01B 15/16; A01B 27/00; A01B 35/16

(57) ABSTRACT

A row cleaner a row cleaner disc defining an inner face and a scraper blade supported relative to the row cleaner disc. The scraper blade includes a mounting portion and a blade portion, with the blade portion extending in a fore-aft direction between a forward end and an aft end and in a lateral direction between an inner lateral end positioned adjacent to the mounting portion and an outer lateral end spaced apart from the mounting portion. The outer lateral end of the blade portion is oriented substantially parallel to the inner face of the row cleaner disc. Additionally, the blade portion is oriented non-perpendicular to the inner face of the row cleaner disc as the blade portion extends from the outer lateral end of the blade portion to the inner lateral end of the blade portion in the lateral direction.

The present application is based upon and claims the right of priority to U.S. Provisional Patent Application No. 63/578,394, filed Aug. 24, 2023, the disclosure of which is hereby incorporated by reference herein in its entirety for all purposes.

### FIELD OF THE INVENTION

### Field of the Invention

The present subject matter relates generally to agricultural implements, such as strip tillage implements and, more particularly, to a row cleaner with disc scrapers or scraper blades for row units of an agricultural implement.

### BACKGROUND OF THE INVENTION

Many agricultural implements include row units for processing a narrow strip of soil during the performance of an agricultural operation. For instance, planters include planter row units for opening a furrow along a narrow strip of soil, depositing a seed within the furrow, and then subsequently closing the furrow. Similarly, strip-tillage implements include strip-tillage row units for tilling a narrow strip of soil to prepare the soil for subsequent planting.

In many instances, row units may include a row cleaner positioned at the forward end of the row unit for removing residue or other trash along the path of the row unit. For example, a strip-tillage row unit may often include a row cleaner including a pair of row cleaner discs positioned at the forward end of the row unit. During operation, the row cleaner discs can accumulate dirt, mud, residue and/or other field materials, which can prevent such discs from performing their row cleaning function.

Accordingly, a row cleaner incorporating disc scrapers or scraper blades for removing or preventing material accumulation relative to the row cleaner discs would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a row cleaner configured for use with an agricultural row unit. The row cleaner includes a row cleaner arm and a row cleaner disc coupled to the row cleaner arm for rotation relative thereto. The row cleaner disc includes a central disc portion and a plurality of teeth extending radially outwardly from the central disc portion. The row cleaner disc also defines an inner face. The row cleaner also includes a scraper blade supported relative to the row cleaner disc and including a mounting portion and a blade portion. The mounting portion of the scraper blade is coupled to the row cleaner arm. The blade portion extends in a fore-aft direction between a forward end and an aft end and in a lateral direction between an inner lateral end positioned adjacent to the mounting portion and an outer lateral end spaced apart from the mounting portion. The outer lateral end of the blade portion is positioned adjacent to the inner face of the row cleaner disc and is oriented substantially parallel to the inner face of the row cleaner disc as the outer lateral end extends between the forward and aft ends of the blade portion. Additionally, the blade portion is oriented non-perpendicular to the inner face of the row cleaner disc as the blade portion extends from the outer lateral end of the blade portion to the inner lateral end of the blade portion in the lateral direction.

In another aspect, the present subject matter is directed to a row unit configured for use with an agricultural implement. The row unit includes a frame and a row cleaner supported relative to the frame. The row cleaner includes a row cleaner arm pivotably coupled to the frame and a row cleaner disc coupled to the row cleaner arm for rotation relative thereto. The row cleaner disc includes a central disc portion and a plurality of teeth extending radially outwardly from the central disc portion. The row cleaner disc also defines an inner face. In addition, the row cleaner includes a scraper blade supported relative to the row cleaner disc, with the scraper blade including a mounting portion and a blade portion. The mounting portion of the scraper blade is coupled to the row cleaner arm. The blade portion extends in a fore-aft direction between a forward end and an aft end and in a lateral direction between an inner lateral end positioned adjacent to the mounting portion and an outer lateral end spaced apart from the mounting portion. The outer lateral end of the blade portion is positioned adjacent to the inner face of the row cleaner disc and is oriented substantially parallel to the inner face of the row cleaner disc as the outer lateral end extends between the forward and aft ends of the blade portion. Moreover, the blade portion is oriented non-perpendicular to the inner face of the row cleaner disc as the blade portion extends from the outer lateral end of the blade portion to the inner lateral end of the blade portion in the lateral direction.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of an agricultural implement in accordance with aspects of the present subject matter;

FIG. 2 illustrates a side view of one embodiment of a row unit suitable for use with the implement shown in FIG. 1 in accordance with aspects of the present subject matter;

FIG. 3 illustrates a perspective view of one embodiment of a blade scraper configured for use with a row cleaner of an agricultural row unit in accordance with aspects of the present subject matter;

FIG. 4 illustrates a perspective view of one embodiment of a row cleaner incorporating the disclosed blade scrapers in accordance with aspects of the present subject matter;

FIG. 5 illustrates a top view of the row cleaner shown in FIG. 4;

FIG. 6 illustrates a side view of the row cleaner shown in FIG. 4;

FIG. 7 illustrates another side view of the row cleaner shown in 4 with the row cleaner discs removed for purposes of illustration; and

FIG. 8 illustrates a rear view of the row cleaner shown in FIG. 4.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to disc scrapers or “scraper blades” configured for use with row cleaners for agricultural row units. Specifically, in several embodiments, the scraper blades may be positioned relative to the row cleaner discs of the row cleaner to prevent or remove accumulated materials from the discs. For instance, the scraper blades may be configured to scrape away or remove field materials that are stuck onto the discs as the discs rotate past the scraper blades during the performance of an agricultural operation. In this regard, as will be described below, the scraper blades may be positioned and/or oriented relative to the row cleaner discs to facilitate effective and efficient removal of the field materials form the discs.

It should be appreciated that, as provided herein, when two components or features are described as being oriented “substantially parallel” relative to each other, it is meant that such components or features or oriented relative to each other either exactly parallel or within a range that is plus or minus (+/−) 5 degrees of parallel. Similarly, when two components or features are described as being oriented “substantially perpendicular” relative to each other, it is meant that such components or features or oriented relative to each other either exactly perpendicular or within a range that is plus or minus (+/−) 5 degrees of perpendicular.

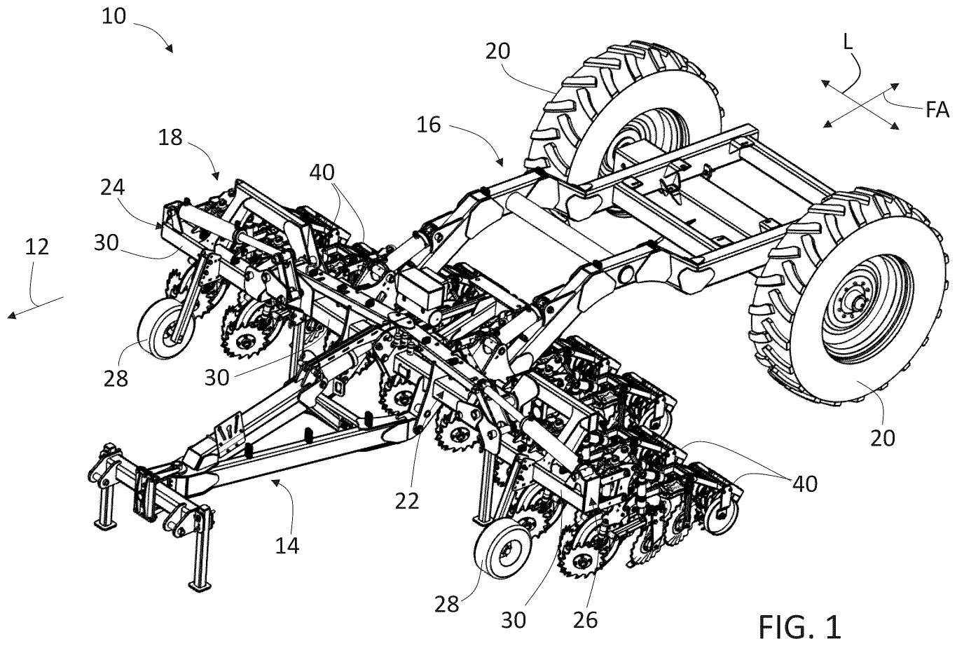

Referring now to the drawings, FIG. 1 illustrates a perspective view of one embodiment of an agricultural implement 10 in accordance with aspects of the present subject matter. In general, the implement 10 may be configured to be towed across a field in a forward direction of travel (e.g., as indicated by arrow 12 in FIG. 1) by a work vehicle (e.g., an agricultural tractor). As shown, the implement 10 is configured as a strip tillage implement. However, in other embodiments, the implement 10 may be configured as any other suitable type of implement, such as a seed-planting implement, a fertilizer-dispensing implement, and/or the like.

As shown in FIG. 1, the implement 10 includes a towbar assembly 14, a chassis assembly 16, and a toolbar assembly 18. As is generally understood, the towbar assembly 14 may be configured to allow the implement 10 to be coupled to a tow vehicle (e.g., a tractor) for towing the implement 10 along a field during the performance of a strip-tillage operation. For instance, the towbar assembly 14 may incorporate a hitch or other suitable coupling for connecting the implement 10 to a tow vehicle. In one embodiment, the chassis assembly 16 may be configured to support one or more storage tanks (not shown). For instance, the storage tank(s) may correspond to a fertilizer tank or any other suitable type of storage tank configured to store an agricultural material. Additionally, the chassis assembly 16 may be coupled to one or more pairs of chassis support wheels 20. For example, as shown in FIG. 1, a pair of support wheels 20 are coupled to the aft end of the chassis assembly 16 to support the implement 10 relative to the ground.

It should be appreciated that, in the illustrated embodiment, the chassis assembly 16 is positioned at the aft end of the implement 10 such that the toolbar assembly 18 is disposed between the towbar assembly 14 and the chassis assembly 16 along the fore-aft direction of the implement 10 (as indicated by arrow FA in FIG. 1). For instance, as shown in FIG. 1, toolbar assembly 18 is pivotably coupled at its forward end to the towbar assembly 14 and at its aft end to the chassis assembly 16. Alternatively, the chassis assembly 16 may be positioned between the towbar assembly 14 and the toolbar assembly 18 in the fore-aft direction FA of the implement 10 such that the toolbar assembly 18 is disposed at the aft end of the implement 10. In such an embodiment, the forward end of the toolbar assembly 18 may be coupled to the aft end of the chassis assembly 16 (e.g., via connecting frame).

In several embodiments, the toolbar assembly 18 may be configured as a winged toolbar assembly. Specifically, as shown in FIG. 1, the toolbar assembly 18 includes a central toolbar section 22 and one or more wing toolbar sections coupled to and extending laterally (e.g., in the lateral direction L) from central toolbar section 22 (e.g., a first wing toolbar section 24 coupled to one lateral end of the central toolbar section 22 and a second wing toolbar section 26 coupled to the opposed lateral end of the central toolbar section 22). Additionally, as shown in FIG. 1, a wing support wheel 28 may be coupled to each wing toolbar section 24, 26 (e.g., at the front of each wing toolbar section 24, 26) to support the toolbar section 24, 26 relative to the ground. In one embodiment, the wing support wheels 28 may be configured to function as gauge wheels for the wing toolbar sections 24, 26.

As is generally understood, each of the various toolbar sections 22, 24, 26 may include one or more laterally extending toolbars 30 configured to support a plurality of row units 40. For instance, in one embodiment, each row unit 40 may be coupled to its respective toolbar 30 via a four-bar linkage. In the illustrated embodiment, the row units 40 are configured as strip tillage units. As such, each row unit 40 may include one or more ground-engaging tools for working the soil in narrow strips extending in the forward direction of travel 12 of implement 10. For instance, in one embodiment, each row unit 40 may include one or more row cleaner discs, coulter discs, shanks or knives, finishing or conditioning units, and/or the like for tilling narrow strips of soil during the performance of a strip tillage operation. Additionally, each row unit 40 may also incorporate one or more components for supplying agricultural materials to the soil, such as injectors or tubes for directing agricultural material (e.g., fertilizer) supplied from a storage tank supported on the chassis assembly 16 (or from any other source) into the worked soil.

It should be appreciated that the configuration of the implement 10 described above and shown in FIG. 1 is provided only to place the present subject matter in an exemplary field of use. Thus, it should be appreciated that the present subject matter may be readily adaptable to any manner of implement configuration.

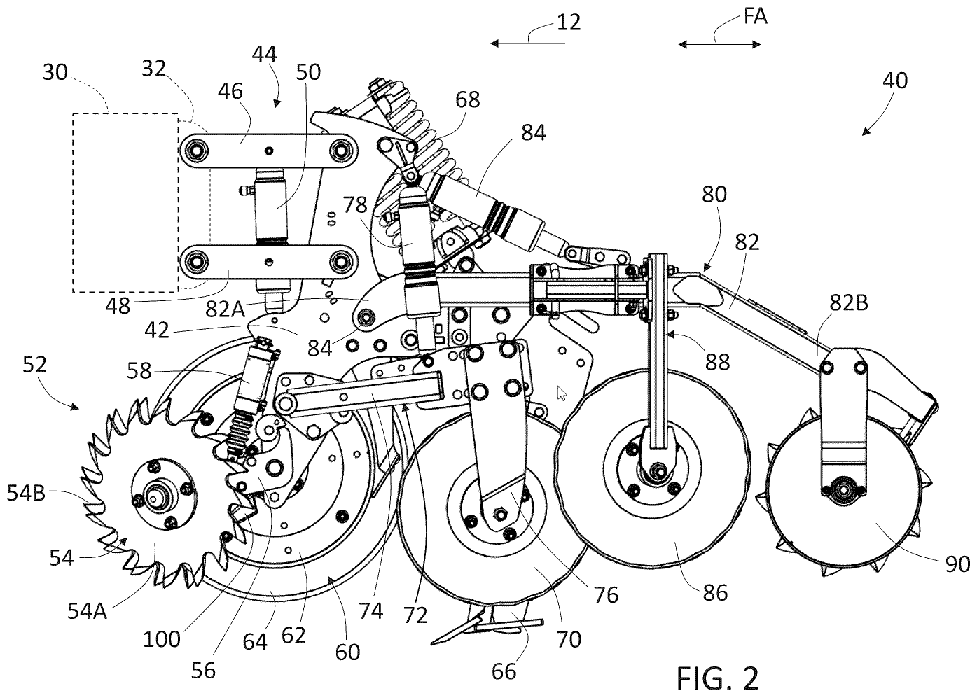

Referring now to FIG. 2, a side view of one embodiment of a row unit 40 suitable for use with the implement 10 shown in FIG. 1 is illustrated in accordance with aspects of the present subject matter. As shown, the row unit 40 includes a main frame or backbone 42 (referred to herein as simply the “frame 42” of the row unit 40) configured to be adjustably coupled to a toolbar (e.g., toolbar 30 and associated mounting bracket(s) 32) of the implement 10 via a linkage assembly 44. For example, in one embodiment, the frame 42 may be coupled to the toolbar 30 via a four-bar linkage including one or more pairs of first and second linkages 46, 48, with one end of each linkage 46, 48 being pivotably coupled to the frame 42 and the opposed end of each linkage 46, 48 being pivotably coupled to the toolbar 30 (e.g., via the associated mounting bracket(s) 32). However, it should be appreciated that, in alternative embodiments, the frame 42 of the row unit 40 may be coupled to the toolbar 30 in any other suitable manner. Additionally, the row unit 40 may include one or more downforce actuators 50 provided in operative association with the linkage assembly 44 for applying a downforce to the row unit 40. In one embodiment, the downforce actuators 50 may be passive actuators, such as air shocks or springs. Alternatively, the downforce actuators 50 may be actively controlled actuators, such as pneumatic or hydraulic cylinders.

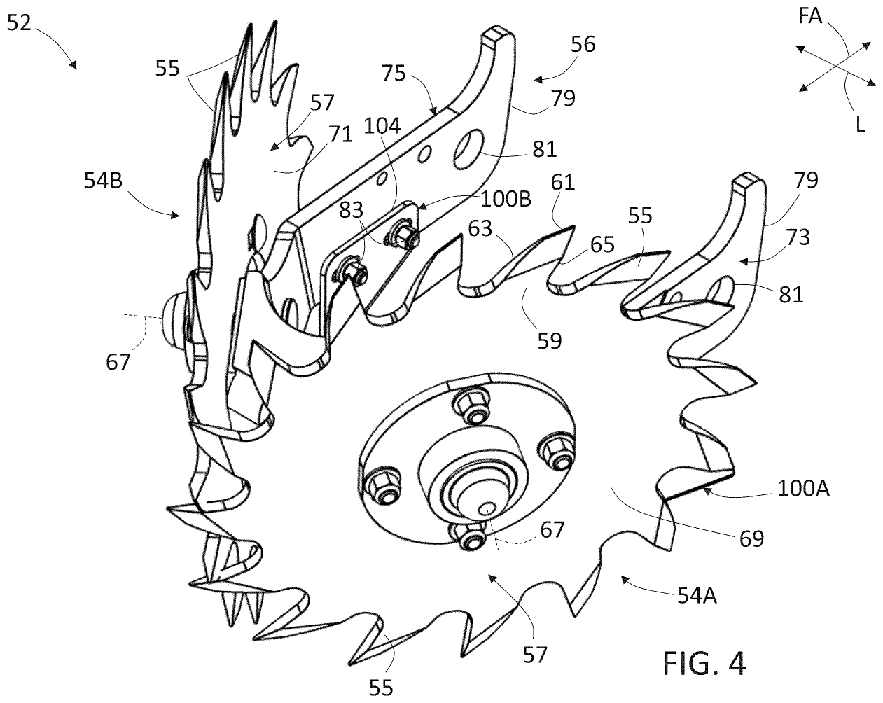

Moreover, as shown in FIG. 2, the row unit 40 may include a plurality of ground-engaging tools coupled to and/or supported by the frame 42. For instance, in several embodiments, the row unit 40 may include a row cleaner assembly or “row cleaner” 52 positioned at the forward end of the row unit 40 relative to the forward direction of travel 12. In general, the row cleaner 52 may be configured to break up and/or sweep away residue, dirt clods, and/or the like from the travel path of the various components positioned downstream or aft of the row cleaner 52. In one embodiment, the row cleaner 52 may include a pair of row cleaner discs 54 (e.g., a first row cleaner disc 54A and a second row cleaner disc 54B), with each disc 54 being pivotably coupled to the main frame via a row cleaner arm 56. As is generally understood, the row cleaner discs 54 may be toothed or spiked, such as by including a plurality of fingers or teeth 55 (FIGS. 4-6 and 8) extending radially outwardly from a central disc portion 57 (FIGS. 4-6 and 8). As such, the discs 54 may be configured to roll relative to the soil as the implement 10 is moved across the field such that the teeth break up and/or sweep away residue and dirt clods. In accordance with aspects of the present subject matter, the row cleaner 52 may also include a pair of scraper blades 100 (i.e., one for each row cleaner disc 52—only one blade 100 being shown in FIG. 2) configured to scrape away or remove dirt, mud, debris, residue, and/or other field materials (generally referred to hereinafter as simply “field materials) from the row cleaner discs 54A, 54B as the discs 54A, 54B are engaging the ground during the performance of an agricultural operation.

Additionally, as shown in FIG. 2, the row unit 40 may also include one or more row cleaner actuators 58 provided in association with the row cleaner 52. For instance, in the illustrated embodiment, the row unit 40 includes one or more row cleaner actuators 58 configured to provide a downward biasing force against the row cleaner 52, with the row cleaner actuator 58 being coupled between the main frame 42 and the row cleaner arm 56. In one embodiment, the row cleaner actuator(s) 58 may be passive actuators, such as air shocks or springs. Alternatively, the row cleaner actuator(s) 58 may be actively controlled actuators, such as pneumatic or hydraulic cylinders.

Moreover, as shown in FIG. 2, the row unit 40 may also include a center coulter 60 positioned generally adjacent the row cleaner 52 relative to the forward direction of travel 12 of the implement 10. The center coulter 60 may generally be aligned with a longitudinal centerline of the row unit 40 such that the coulter 60 is positioned in the center of the row unit 40 relative to the lateral direction L of the implement 10 (i.e., the direction into and out of the page in FIG. 2). In one embodiment, the center coulter 60 may include a central disc portion 62 coupled to the main frame 42 for rotation relative thereto and a peripheral blade 64 extending radially outwardly from the disc portion 62 around its outer perimeter. The center coulter 60 may generally be configured to cut a slot or slit within the field along the center of the “row” being processed or formed by the row unit 40. Additionally, the center coulter 60 may also function together with the row cleaner 52 to ensure that residue and other trash is swept or moved laterally away from the travel path of further downstream components of the row unit 40. For instance, the relative positioning between the row cleaner discs 54 and the center coulter 60 may allow such component to efficiently and effectively process residue in the path of the row unit 40. Specifically, as the row cleaner discs 54 rotate relative to the ground, the discs 54 may be configured to trap residue against the surface of the field. The blade 64 of center coulter 60 may then slice or cut through the trapped residue extending between the pair of row cleaner discs 54, thereby allowing the cut residue to be swept away from the longitudinal centerline of the row unit 40 via the action of the row cleaner discs 54.

Referring still to FIG. 2, in several embodiments, the row unit 40 may include a centralized shank 66 mounted to the main frame 42 at a location aft of the central disc portion 62 relative to the forward direction of travel 12 of the implement 10. In one embodiment, the shank 66 may generally be aligned with the center coulter 60 along the longitudinal centerline of the row unit 40 (i.e., aligned with the center coulter 60 in the longitudinal direction of the implement 10). The shank 66 may be configured to break out the soil along the lateral width of the row being formed by the row unit 40 at a location aft of the center coulter 60. For example, the shank 66 may be aligned with the blade 64 of the center coulter 60 such that the shank 66 travels through and breaks open the slit or slot cut into the soil via the center coulter 60. As shown in FIG. 2, the row unit 40 may also include one or more shank actuators 68 provided in association with the shank 66 for providing a downward biasing force thereto. For instance, in the illustrated embodiment, the row unit 40 includes a pair of shank actuators 68, with each shank actuator 68 being coupled between the main frame 42 and the shank 66. In one embodiment, the shank actuators 68 may be passive actuators, such as air shocks or springs. Alternatively, the shank actuators 68 may be actively controlled actuators, such as pneumatic or hydraulic cylinders. In alternative embodiments, the shank 66 may be replaced with a different ground-engaging tool, such as centralized knife positioned immediately aft of the center coulter 60.

Additionally, in several embodiments, the row unit 40 may include a forward or first pair of side coulter discs 70 (only one of which is shown in FIG. 2) positioned immediately aft of the center coulter 60 relative to the forward direction of travel 12, with each first side coulter disc 70 being disposed along either side of the shank 66 such that the discs 70 are spaced apart from the shank 66 in the lateral direction L of the implement 10. In one embodiment, each first side coulter disc 70 is pivotably coupled to the main frame 42 via a first side coulter mount assembly 72. For instance, as shown in FIG. 2, the side coulter arm assembly 72 includes a mounting arm 74 and a support arm 76, with the mounting arm 74 being pivotably coupled to the main frame 42 at one end and being coupled to the support arm 76 at the other end. The support arm 76 may, in turn, be coupled between the mounting arm 74 and its respective first side coulter disc 70 in a manner that allows the coulter disc 70 to rotate relative to the support arm 76 as the row unit 40 is being moved across the field. As shown in FIG. 2, the row unit 40 may also include one or more side coulter actuators 78 provided in association with the side coulters 78 for applying a downward biasing force thereto. For instance, in the illustrated embodiment, the row unit 40 includes a pair of side coulter actuators 78 (only one of which is shown in FIG. 2), with each side coulter actuator 78 being coupled between the main frame 42 and a respective coulter arm assembly 72. In one embodiment, the side coulter actuators 78 may be passive actuators, such as air shocks or springs. Alternatively, the side coulter actuators 78 may be actively controlled actuators, such as pneumatic or hydraulic cylinders.

In several embodiments, the side coulter discs 70 may function together with the central shank 66 to break out the soil along the width of the strip being worked or formed by the row unit 40. For instance, the side coulter discs 70 may be configured to “score” the soil to provide a pre-fracture at the desired width of the strip being formed. As an example, the side coulter discs 70 may be configured to run at a relatively shallow depth (e.g., 1-2 inches) to create scores or fracture lines” within the soil along the lateral edges of the row being formed. The shank 66 may, in turn, be configured to break out the hard soil across the lateral width extending between the fracture lines created by the side coulter discs 70.

Moreover, in several embodiments, the row unit 40 may include an aft frame assembly 80 coupled to the main frame 42 for supporting additional ground-engaging tools of the row unit 40. As shown in FIG. 2, the aft frame assembly 80 may include a pair of aft frame members 82 (only one of which is shown in FIG. 2) extending between a forward end 82A and an aft end 82B, with the forward end 82A of each frame member 82 being pivotably coupled to the main frame 42 at a forward pivot point 44. Each frame member 82 extends rearwardly from the pivot point 44 relative to the forward direction of travel 12 to its aft end 82B positioned adjacent to the aft end of the row unit 40. Additionally, in one embodiment, the row unit 40 may include one or more aft frame actuators 84 provided in association with the aft frame assembly 80 for providing a downward biasing force to the frame assembly 80 (and any ground-engaging tools supported thereby). For instance, in the illustrated embodiment, the row unit 40 includes a pair of aft frame actuators 84 (only one of which is shown in FIG. 2), with each aft frame actuator 84 being coupled between the main frame 42 and a respective aft frame member 82 of the aft frame assembly 80. In one embodiment, the aft frame actuators 84 may be passive actuators, such as air shocks or springs. Alternatively, the aft frame actuators 84 may be actively controlled actuators, such as pneumatic or hydraulic cylinders.

As shown in FIG. 2, in several embodiments, the aft frame assembly 80 may be configured to support an aft or second pair of side coulter discs 86 positioned aft or rearward of the forward or first pair of side coulter discs 70 (and aft of the shank 66) relative to the forward direction of travel 12, with each second side coulter disc 86 being disposed along either side of the longitudinal centerline of the row unit 40 such that the discs 86 are spaced apart from the centerline in the lateral direction L of the implement 10. In one embodiment, the second side coulter discs 86 may be configured to catch or block the soil coming off of the first side coulter discs 70 and shank 66 and redirect such soil back towards the center of the row being formed. As a result of redirecting the thrown soil back towards the center of the row, the aft or second side coulter discs 86 may function as “berm builders” to create a berm of soil along the centerline of the row unit 40. In such instance, the second side coulter discs 86 may be set to run at a relatively shallow depth (e.g., 1 inch or less) so that the coulter discs 86 can catch the soil without effectively tilling the soil. Alternatively, the second side coulter discs 86 may be set at a less shallow depth to allow the coulter discs 86 to perform shallow tillage (e.g., to widen the strip of worked soil beyond what the first side coulter discs 70 achieved) while still performing the function of directing soil into the right lateral shape to build a proper berm across the width of the row. In one embodiment, each second side coulter disc 86 is coupled to the aft frame assembly 80 via a second side coulter mount assembly 88. In one embodiment, the side coulter mount assembly 88 may be configured to allow the positioning of the second side coulter discs 86 to be adjusted relative to the other tools of the row unit 40, thereby allowing the coulter discs 86 to be set properly for performing their soil-catching function.

Moreover, as shown in FIG. 2, the row unit 40 may also include a finishing tool positioned at the aft end of the row unit 40. Specifically, in the illustrated embodiment, the row unit 40 includes a strip conditioner 90 coupled to the aft end 82B of the aft frame assembly 80. In general, the strip conditioner 90 may have any suitable configuration that allows it to perform its function as a finishing tool. In one embodiment, the strip conditioner 90 may be configured as a spider conditioner that functions to reduce the size of soil clods across the width of the row being formed. In other embodiments, a conditioning reel or basket may be used as the finishing tool.

It should be appreciated that the configuration of the row unit 40 described above and shown in FIG. 2 is provided only to place the present subject matter in an exemplary field of use. Thus, it should be appreciated that the present subject matter may be readily adaptable to any manner of row unit configuration.

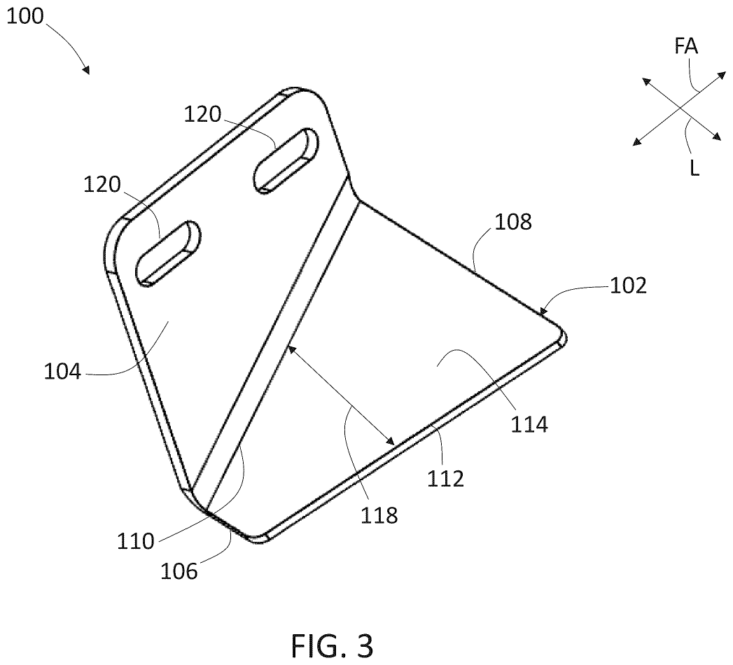

Referring now to FIG. 3, a perspective view of one embodiment of a scraper blade 100 suitable for use with a row cleaner of an agricultural row unit is illustrated in accordance with aspects of the present subject matter. As shown, the scraper blade 100 may generally have a blade or plate-like configuration including a blade portion 102 and a mounting portion 104. In general, the blade portion 102 may be configured to extend in the fore-aft direction FA between a forward end 106 and an aft end 108 and in the lateral direction L between an inner lateral end 110 (referred to hereinafter often as simply “inner end 110”) positioned adjacent to the mounting portion 104 and outer lateral end 112 (referred to hereinafter often as simply “outer end 112”) spaced apart from the mounting portion. In the illustrated embodiment, the blade portion 102 and the mounting portion 104 are formed integrally as a single component, with the blade portion 102 transitioning to the mounting portion 104 (and vice versa) at the inner end 110 of the blade portion 102. The outer end 112 of the blade portion 102 may generally defined the working end or edge of the blade 100.

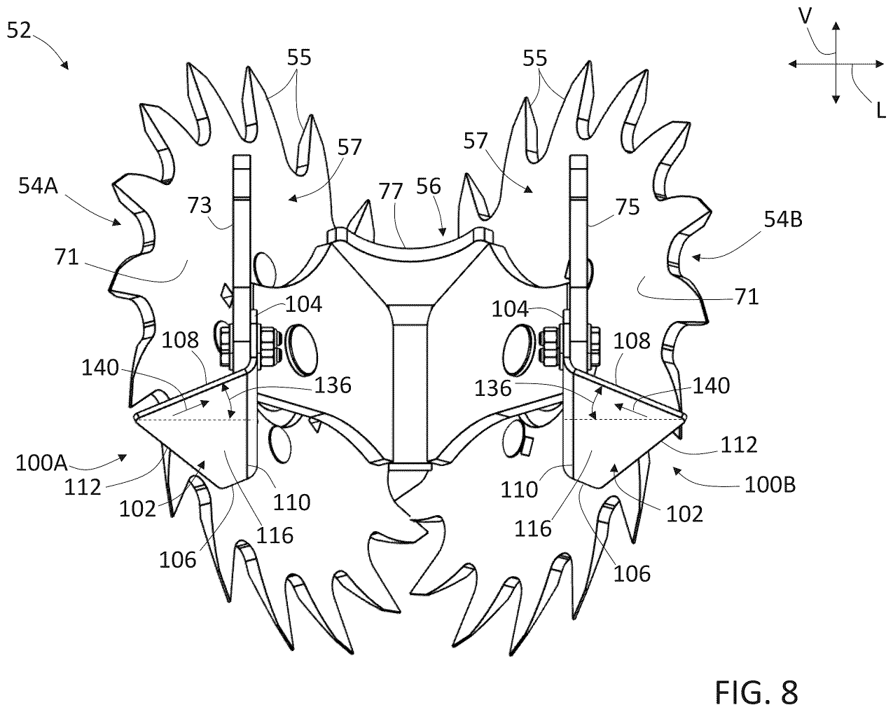

The blade portion 102 may also define an upper face 114 and a lower face 116 (FIG. 8) extending in the fore-aft direction FA between the forward and aft ends 106, 108 and in the lateral direction L between the inner and outer ends 110, 112. As will be described below, the scraper blade 100 may be configured to be supported relative to an associated row cleaner disc 54A, 54B such that the outer end 112 of the scraper blade 100 is positioned directly adjacent to an inner face of the disc 54A, 54B. For example, in one embodiment, the outer end 112 of the scraper blade 100 may be configured to extend substantially parallel to a plane defined by the inner face of the row cleaner disc 54A, 54B while the upper and lower faces 114, 116 of the blade portion 102 are generally oriented non-perpendicular to the plane defined by the inner face of the row cleaner disc 54A, 54B. Additionally, as shown in FIG. 3, a lateral width 118 of the blade portion 102 defined between its inner and outer ends 110, 112 in the lateral direction L may generally be configured to increase as the blade portion 102 extends from its forward end 106 to its aft end 108 in the fore-aft direction FA. As such, the upper and lower faces 114, 116 of the blade portion 102 may generally taper outwardly as the blade portion 102 extends in the fore-aft direction FA

The mounting portion 104 of the scraper blade 100 may generally be configured to allow the blade 100 to be mounted or coupled to an adjacent component of the row unit. For instance, as will be described below, the mounting portion 104 may be configured to be coupled to the row cleaner arm 56 of the row cleaner 52 in a manner that permits the scraper blade 100 to be supported relative to its associated row cleaner disc 54A, 54B. In this regard, as shown in FIG. 3, the mounting portion 104 may define fastener openings 120 configured to receive suitable fasteners for securing the scraper blade 100 to the row cleaner arm 56 of the row cleaner 52.

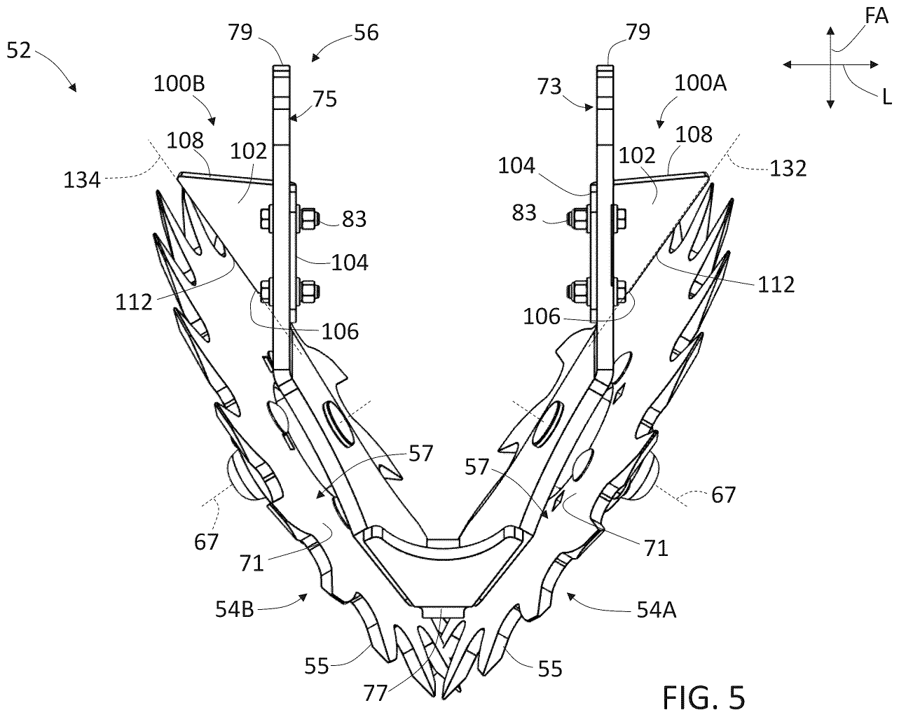

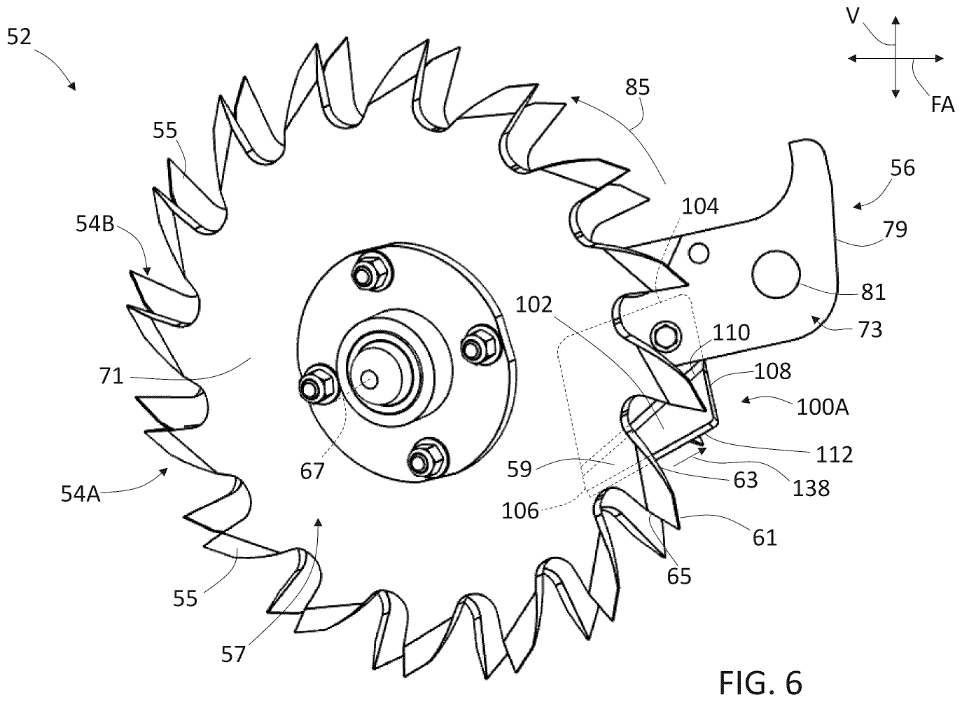

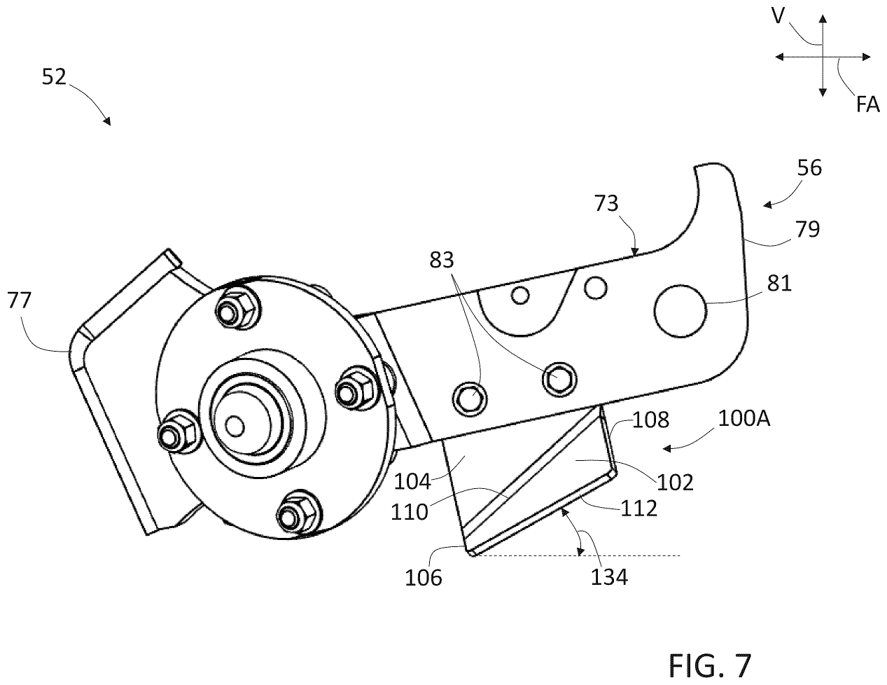

Referring now to FIGS. 4-8, various views of one embodiment of a row cleaner 52 incorporating the disclosed scraper blades 100 are illustrated in accordance with aspects of the present subject matter. Specifically, FIGS. 4 and 5 illustrate perspective and top views, respectively, of the row cleaner 52. FIG. 6 illustrates a side view of the row cleaner 52 shown in FIG. 4 with a portion of the scraper blade hidden behind the first row cleaner disc 54A shown in dashed lines for purposes of illustration. FIG. 7 illustrates another side view of the row cleaner 52 similar to that shown in FIG. 6 but with the row cleaner discs 54A, 54B removed for purposes of illustration. Additionally, FIG. 8 illustrates a rear view of the row cleaner 52 shown in FIG. 4. It should be appreciated that, for purposes of discussion, the row cleaner 52 will generally be described herein in relation to the row unit 42 described above with reference to FIG. 2. However, in general, the disclosed row cleaner 52 and related scraper blades 100 may be advantageously utilized with any suitable row unit having any suitable row unit configuration.

As indicated above, the row cleaner 52 generally includes a pair of row cleaner discs (e.g., a first row cleaner disc 54A and a second row cleaner disc 54B). Each row cleaner disc 54A, 54B may generally include a central disc portion 57 and a plurality of teeth 55 extending radially outwardly from the central disc portion 57. As particularly shown in FIG. 3, each tooth 55 may generally extend radially between a base end 59 joined with the central disc portion 57 (e.g., by being formed integrally therewith) and a tip end 61 spaced apart radially outwardly from the base end 59. Additionally, as shown in FIG. 3, each tooth 55 may include a leading edge 63 and a trailing edge 65 extending between the base and tip ends 59, 61 of the tooth 55. The central disc portion 57 of each row cleaner disc 54A, 54B may generally extend radially between a rotational axis 67 (FIGS. 4-6) of the row cleaner disc 54A, 54B and the base ends 59 of the teeth 55 of such disc 54A, 54B. As shown in FIGS. 4 and 5, the central disc portion 57 may generally have a planar profile and may define an outer planar face or “outer face” 69 (FIGS. 4 and 6) and an inner planar face or “inner face” 71 (FIGS. 4, 5, and 8) of each row cleaner disc 54A, 54B.

Additionally, as indicated above, each row cleaner disc 54A, 54B may be configured to be pivotably coupled to the main frame 42 (FIG. 2) via a row cleaner arm 56. As shown in the illustrated embodiment, the row cleaner arm 56 may generally include a first arm portion 73 configured to support the first row cleaner disc 54A relative to the main frame 42 and a second arm portion 75 configured to support the second row cleaner disc 54B relative to the main frame 42, with the first and second arm portions 73, 75 being joined together at a forward end 77 (FIG. 5) of the row cleaner arm 56 that is nested or located between the row cleaner discs 54A, 54B. Each arm portion 73, 75 may generally extend rearwardly from the forward end 77 of the row cleaner arm 26 to respective aft ends 79 of the arm portions 73, 75. In general, each arm portion 73, 75 may be configured to be pivotably coupled to the main frame 42 of the row unit 40 at or adjacent to aft end 79 of each arm portion 73, 75, such as by configuring each arm portion 73, 75 to be pivotably coupled to the main frame 42 via pivot openings 81 defined through each arm portion 73, 75. As indicated above, one or more row cleaner actuators 58 (FIG. 2) may be coupled between the main frame 42 and the row cleaner arm 56 to provide a downward biasing force against the row cleaner 52, thereby maintaining the row cleaner discs 54A, 54B in engagement with the soil.

Moreover, as indicated above, the row cleaner 52 may also include a pair of scraper blades (i.e., a first scraper blade 100A and a second scraper blade 100B) configured to scrape away or otherwise remove field materials from the row cleaner discs 54A, 54B during the performance of an agricultural operation. In general, each scraper blade 100A, 100B is configured the same as the scraper blade 100 described above with reference to FIG. 3 except that the scraper blades 100A, 100B have a mirrored configuration relative to each other to allow the blades 100A, 100B to be positioned along opposed sides of the row cleaner arm 56 adjacent to each blade's respective row cleaner disc 54A, 54B. Specifically, as shown in the illustrated embodiment, the first scraper blade 100A is configured to be mounted to the first arm portion 73 of the row cleaner arm 56 such that the scraper blade 100A is supported adjacent to the first row cleaner disc 54A. Similarly, the second scraper blade 100B is configured to be mounted to the second arm portion 75 of the row cleaner arm 56 such that the scraper blade 100B is supported adjacent to the second row cleaner disc 54B. As indicated above with reference to FIG. 3, the mounting portion 104 of each scraper blade 100A, 100B may define fastener openings 120 (FIG. 3) configured to receive suitable fasteners 83 for coupling the blades 100A, 100B to the row cleaner arm 56.

Additionally, as indicated above, each scraper blade 100A, 100B may be configured to be supported relative to its respective row cleaner disc 54A, 54B such that the outer end 112 of the blade portion 102 is positioned adjacent to the inner face 71 of the disc 54A, 54B, with the outer lateral end 112 extending substantially parallel to the inner face 71 between the forward and aft ends 106, 108 of the blade portion 102. For example, as particularly shown in FIG. 5, the outer end 112 of the first scraper blade 100A may generally extend between the forward and aft ends 106, 108 of the blade portion 102 along a first end plane (indicated by dashed line 130 in FIG. 5) that is oriented substantially parallel to the inner face 71 of the first row cleaner disc 54A. Similarly, the outer end 112 of the second scraper blade 100B may generally extend between the forward and aft ends 106, 108 of the blade portion 102 along a second end plane (indicated by dashed line 132 in FIG. 5) that is oriented substantially parallel to the inner face 71 of the second row cleaner disc 54B. Such a substantially parallel orientation between the outer ends 112 of the scraper blades 100A, 100B and the inner faces 71 of the row cleaner discs 54A, 54B may generally allow for effective removal of field materials from the discs 54A, 54B.

As particularly shown in FIG. 6, the blade portion 102 of each scraper blade 100A, 100B may also be positioned relative to its respective row cleaner disc 54A, 54B such that the outer end 112 spans radially across the entire radial length of the disc's teeth 55. For instance, as shown in FIG. 6, the forward end 106 of the blade portion 102 (shown in dashed lines) is positioned radially inwardly from the base end 59 of the teeth 55 while the aft end 108 of the blade portion 102 is positioned radially outwardly from the tip end 61 of the teeth 55. As a result, the entirety of each tooth 55 may pass across the outer end 112 of the scraper blade 100A, 100B as the respective row cleaner disc 54A, 54B is rotated relative thereto (e.g., in rotational direction 85 shown in FIG. 6).

Moreover, as shown in the side views of FIGS. 6 and 7, the blade portion 102 of each scraper blade 100A, 100B may be oriented such that the outer end 112 of the scraper blade 100A, 100B is angled upwardly (the vertical direction being indicated by arrow V in FIGS. 6-8) relative to the fore-aft direction FA as the blade portion 102 extends from its forward end 106 to its aft end 108. For example, as shown in FIG. 7, the outer end 112 of the blade portion 102 is oriented upwardly at a fore-aft end angle 134 as it extends from the forward end 106 of the blade portion 102 to the aft end 108 of the blade portion 102. In one embodiment, this fore-aft end angle 134 may generally be selected such that the portion of the leading edge 63 of each tooth 55 passing across the outer end 112 of the blade portion 102 is oriented substantially perpendicular to the outer end 112. For instance, as shown in FIG. 6, the leading edge 63 of each tooth 55 defines a curved profile as it extends between the base and tip ends 59, 61 of the tooth 55. In this regard, the fore-aft end angle 134 of the outer end 112 of each scraper blade 100A, 100B may be selected based at least in part on the curvature of the leading edges 63 of the teeth 55 such that, as each portion of the curved leading edge 53 of each tooth 55 passes across the outer end 112 of the scraper blade 100A, 100B, such portion of the curved leading edge 63 is oriented substantially perpendicular to the outer end 112. Such a substantially perpendicular orientation between the outer end 112 of each scraper blade 100A, 100B and the leading edges 63 of the teeth 55 may generally provide for an enhanced scraping action across the full length of the leading edge 63 of each tooth 55 (i.e., the full length extending from the base end 59 to the tip end 61 of the tooth 55).

Referring particularly to FIGS. 6-8, in addition to the general orientation of the outer ends 112 of the scraper blades 100A, 100B, the remainder of the blade portion 102 of each scraper blade 100A, 100B may generally be oriented at a compound angle relative to its respective row cleaner disc 54A, 54B. As such, the upper and lower faces 114, 116 of the each blade portion 102 may generally be oriented non-perpendicular (and non-parallel) to the inner face 71 of the respective row cleaner disc 54A, 54B. For example, in several embodiments, the blade portion 102 of each scraper blade 100A, 100B may be angled upwardly as it extends in the lateral direction L from the outer end 112 and to the inner end 110 of the blade portion 102. Specifically, as shown in FIG. 8, the blade portion 102 of each scraper blade 100A, 100B is oriented upwardly at a lateral skew angle 136 as it extends from the outer end 112 of the blade portion 102 to the inner end 110 of the blade portion 102 in the lateral direction L. As shown in FIG. 7, given this upwardly oriented, lateral skew angle 136 of the blade portion 102, the inner end 110 of the blade portion 102 may generally be positioned vertically above the outer end 112 of the blade portion 102 along the fore-aft length of the scraper blade 100A, 100B extending from the forward end 106 to the aft end 108 of the blade portion 102.

It should be appreciated that, by configuring the outer end 112 of each scraper blade 100A, 100B to be oriented upwardly at the fore-aft end angle 134 relative to the fore-aft direction FA and by configuring the remainder of the blade portion 102 (e.g., the upper and lower faces 114, 116 of the blade portion 102) to be upwardly oriented at the lateral skew angle 136 relative to the lateral direction L, field materials removed from each row cleaner disc 54A, 54B may be directed away from the disc 54A, 54B. Specifically, the orientation of the scraper blade 100A, 100B may result in the field materials scraped away from the row cleaner discs 54A, 54B being directed both upwardly and rearwardly in the fore-aft direction FA (as indicated by arrow 138 in FIG. 6) and upwardly and inwardly in the lateral direction L (as indicated by arrow 140 in FIG. 7) across the planar face of the blade portion 102 to prevent plugging and ensure effective removal of the field materials relative to the discs 54A, 54B.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A row cleaner configured for use with an agricultural row unit, the row cleaner comprising:
a row cleaner arm;
a row cleaner disc coupled to the row cleaner arm for rotation relative thereto, the row cleaner disc including a central disc portion and a plurality of teeth extending radially outwardly from the central disc portion, the row cleaner disc defining an inner face; and
a scraper blade supported relative to the row cleaner disc and including a mounting portion and a blade portion, the mounting portion of the scraper blade being coupled to the row cleaner arm, the blade portion extending in a fore-aft direction between a forward end and an aft end and in a lateral direction between an inner lateral end positioned adjacent to the mounting portion and an outer lateral end spaced apart from the mounting portion;
wherein:
the outer lateral end of the blade portion is positioned adjacent to the inner face of the row cleaner disc and is oriented substantially parallel to the inner face of the row cleaner disc as the outer lateral end extends between the forward and aft ends of the blade portion; and
the blade portion is oriented non-perpendicular to the inner face of the row cleaner disc as the blade portion extends from the outer lateral end of the blade portion to the inner lateral end of the blade portion in the lateral direction.

2. The row cleaner of claim 1, wherein:
each tooth of the plurality of teeth of the row cleaner disc extends radially between a base end joined with the central disc portion and a tip end spaced radially outwardly form the base end; and
the scraper blade is positioned relative to the row cleaner disc such that the forward end of the blade portion is positioned radially inwardly from the base end of each tooth and the aft end of the blade portion is positioned radially outwardly from the tip end of each tooth.

3. The row cleaner of claim 1, wherein the outer lateral end of the blade portion is angled upwardly relative to the fore-aft direction as the outer lateral end extends from the forward end of the blade portion to the aft end of the blade portion.

4. The row cleaner of claim 1, wherein:
each tooth of the plurality of teeth of the row cleaner disc extends radially between a base end joined with the central disc portion and a tip end spaced radially outwardly form the base end;
each tooth of the plurality of teeth of the row cleaner disc includes a leading edge extending between the base and tip ends of the tooth; and
the blade portion is oriented relative to the row cleaner disc such that a portion of the leading edge of each tooth is oriented substantially perpendicular to the outer lateral end of the blade portion as such portion of the leading edge of each tooth passes across the outer lateral end with rotation of the row cleaner disc relative to the scraper blade.

5. The row cleaner disc of claim 1, wherein the blade portion is angled upwardly relative to the lateral direction as the blade portion extends from the outer lateral end of the blade portion to the inner lateral end of the blade portion.

6. The row cleaner disc of claim 5, wherein the upwardly angled orientation of the blade portion relative to the lateral direction results in the inner lateral end of the blade portion being positioned vertically above the outer lateral end of the blade portion.

7. The row cleaner of claim 1, wherein:
the outer lateral end of the blade portion is angled upwardly relative to the fore-aft direction as the outer lateral end extends from the forward end of the blade portion to the aft end of the blade portion; and
the blade portion is angled upwardly relative to the lateral direction as the blade portion extends from the outer lateral end of the blade portion to the inner lateral end of the blade portion.

8. The row cleaner of claim 7, wherein:
each tooth of the plurality of teeth of the row cleaner disc extends radially between a base end joined with the central disc portion and a tip end spaced radially outwardly form the base end;
each tooth of the plurality of teeth of the row cleaner disc includes a leading edge extending between the base and tip ends of the tooth; and
the blade portion is oriented relative to the row cleaner disc such that a portion of the leading edge of each tooth is oriented substantially perpendicular to the outer lateral end of the blade portion as such portion of the leading edge of each tooth passes across the outer lateral end with rotation of the row cleaner disc relative to the scraper blade.

9. The row cleaner disc of claim 7, wherein the upwardly angled orientation of the blade portion relative to the lateral direction results in the inner lateral end of the blade portion being positioned vertically above the outer lateral end of the blade portion.

10. A row unit configured for use with an agricultural implement, the row unit comprising:
a frame;
a row cleaner supported relative to the frame, the row cleaner comprising:
a row cleaner arm pivotably coupled to the frame;
a row cleaner disc coupled to the row cleaner arm for rotation relative thereto, the row cleaner disc including a central disc portion and a plurality of teeth extending radially outwardly from the central disc portion, the row cleaner disc defining an inner face; and
a scraper blade supported relative to the row cleaner disc and including a mounting portion and a blade portion, the mounting portion of the scraper blade being coupled to the row cleaner arm, the blade portion extending in a fore-aft direction between a forward end and an aft end and in a lateral direction between an inner lateral end positioned adjacent to the mounting portion and an outer lateral end spaced apart from the mounting portion;
wherein:
the outer lateral end of the blade portion is positioned adjacent to the inner face of the row cleaner disc and is oriented substantially parallel to the inner face of the row cleaner disc as the outer lateral end extends between the forward and aft ends of the blade portion; and
the blade portion is oriented non-perpendicular to the inner face of the row cleaner disc as the blade portion extends from the outer lateral end of the blade portion to the inner lateral end of the blade portion in the lateral direction.

11. The row unit of claim 10, wherein:
each tooth of the plurality of teeth of the row cleaner disc extends radially between a base end joined with the central disc portion and a tip end spaced radially outwardly form the base end; and
the scraper blade is positioned relative to the row cleaner disc such that the forward end of the blade portion is positioned radially inwardly from the base end of each tooth and the aft end of the blade portion is positioned radially outwardly from the tip end of each tooth.

12. The row unit of claim 10, wherein the outer lateral end of the blade portion is angled upwardly relative to the fore-aft direction as the outer lateral end extends from the forward end of the blade portion to the aft end of the blade portion.

13. The row unit of claim 10, wherein:
each tooth of the plurality of teeth of the row cleaner disc extends radially between a base end joined with the central disc portion and a tip end spaced radially outwardly form the base end;
each tooth of the plurality of teeth of the row cleaner disc includes a leading edge extending between the base and tip ends of the tooth; and
the blade portion is oriented relative to the row cleaner disc such that a portion of the leading edge of each tooth is oriented substantially perpendicular to the outer lateral end of the blade portion as such portion of the leading edge of each tooth passes across the outer lateral end with rotation of the row cleaner disc relative to the scraper blade.

14. The row unit of claim 10, wherein the blade portion is angled upwardly relative to the lateral direction as the blade portion extends from the outer lateral end of the blade portion to the inner lateral end of the blade portion.

15. The row unit of claim 14, wherein the upwardly angled orientation of the blade portion relative to the lateral direction results in the inner lateral end of the blade portion being positioned vertically above the outer lateral end of the blade portion.

16. The row unit of claim 10, wherein:
the outer lateral end of the blade portion is angled upwardly relative to the fore-aft direction as the outer lateral end extends from the forward end of the blade portion to the aft end of the blade portion; and
the blade portion is angled upwardly relative to the lateral direction as the blade portion extends from the outer lateral end of the blade portion to the inner lateral end of the blade portion.

17. The row unit of claim 16, wherein:
each tooth of the plurality of teeth of the row cleaner disc extends radially between a base end joined with the central disc portion and a tip end spaced radially outwardly form the base end;
each tooth of the plurality of teeth of the row cleaner disc includes a leading edge extending between the base and tip ends of the tooth; and
the blade portion is oriented relative to the row cleaner disc such that a portion of the leading edge of each tooth is oriented substantially perpendicular to the outer lateral end of the blade portion as such portion of the leading edge of each tooth passes across the outer lateral end with rotation of the row cleaner disc relative to the scraper blade.

18. The row unit of claim 16, wherein the upwardly angled orientation of the blade portion relative to the lateral direction results in the inner lateral end of the blade portion being positioned vertically above the outer lateral end of the blade portion.
